(19) United States
(12) Patent Application Publication
(10) Pub. No.: US 2010/0086061 A1
(43) Pub. Date: Apr. 8, 2010

(54) VIDEO SIGNAL PROCESSING APPARATUS AND METHOD THEREOF

(75) Inventors: Wen Hao Chung, Sanchong City (TW); Yuan Teng Chang, Fongshan City (TW)

Correspondence Address: EGBERT LAW OFFICES, 412 MAIN STREET, 7TH FLOOR, HOUSTON, TX, 77002, US

(73) Assignee: INDUSTRIAL TECHNOLOGY RESEARCH Institute, Hsinchu (TW)

(21) Appl. No.: 12/431,548

(22) Filed: Apr. 28, 2009

(30) Foreign Application Priority Data
Oct. 3, 2008 (TW) 097138048

(51) Int. Cl. H04N 7/24

(52) U.S. Cl. 375/240.26; 375/E07.003

(57) ABSTRACT

A video signal processing method comprises the steps of: decoding the significant coefficient flag of a stream of video signals and constructing a stack of run coefficients at the same time; and sequentially outputting the run and level coefficients according to the stack of run coefficients and the stream of video signals.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to a video signal processing apparatus and the method thereof, and more particularly, to an apparatus and the method thereof for transforming video signals into run coefficient and level coefficient.

2. Description of Related Art

Including Information Disclosed Under 37 CFR 1.97 and 37 CFR 1.98.

Context-based adaptive binary arithmetic coding (CABAC) is one entropy coding algorithm of the H.264 video coding algorithm. Compared to another entropy coding algorithm of the H.264 algorithm, context adaptive variable length coding (CALVC), the CABAC algorithm exhibits greater efficiency by 9% to 14%. However, when applying the CABAC algorithm for H.264 video coding algorithm, the output efficiency of the block coefficients in the CABAC algorithm is inferior to that of the CALVC algorithm.

There are two steps in the CABAC algorithm. The first step is to establish a significant map, that is, to determine the significant coefficient flag (SCF) for each block coefficient. If the block coefficient is not 0, then the corresponding SCF is 1. If the block coefficient is 0, then the corresponding SCF is 0. If the decoded SCF is 1, then the determination of a last significant coefficient flag (LSCF) is required. If the corresponding block coefficient is the last non-zero coefficient, then the LSCF is 1; otherwise the LSCF is 0.

The following table illustrates an example of a significant map, wherein Index is the index of the block coefficients.

| | Index | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| SCF | 1 | 0 | 0 | 1 | 0 | 0 | 0 | 1 | 1 | 0 | 0 | 0 | 0 | 0 | 0 | 0 |
| LSCF | 0 | x | x | x | x | x | x | 0 | 1 | x | x | x | x | x | x | x |

The second step is to determine, based on the significant map, whether to decode the level coefficient of each block coefficient. The decoding order is reversed with that of the establishment of the significant map. If the SCF is 0, then a 0 is outputted directly. If the SCF is 1, then a coefficient absolute level minus 1 (CALM) and a coefficient sign flag (CSF) are decoded, and an output data is calculated according to the CALM and the CSF.

The following table illustrates a decoding example following the last example of the significant map:

| | Index | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| SCF | 1 | 0 | 0 | 1 | 0 | 0 | 0 | 1 | 1 | 0 | 0 | 0 | 0 | 0 | 0 | 0 |
| LSCF | 0 | x | x | x | x | x | x | 0 | 1 | x | x | x | x | x | x | x |
| CALM | 3 | x | x | 1 | x | x | x | 0 | 0 | x | x | x | x | x | x | x |
| CSF | 0 | x | x | 0 | x | x | x | 0 | 1 | x | x | x | x | x | x | x |
| output | 4 | 0 | 0 | 2 | 0 | 0 | 0 | 1 | −1 | 0 | 0 | 0 | 0 | 0 | 0 | 0 |

Approximately 90% of the output data are 0. Such repetition of outputting the same information reduces output efficiency. In other words, outputting the corresponding data for every block coefficient is the main reason that the CABAC algorithm might has lower output efficiency.

Transforming the output data of the CABAC algorithm into run-level coefficients and then outputting those run-level coefficients instead brings the advantages of reduction of output periods. Referring to the aforesaid example, the disclosed signal processing system transforms the output values into run-level pairs (run, 7), (level, -1), (level, 1), (run, 3), (level, 2), (run, 2) and (level, 4). In other words, the disclosed signal processing system reduced the output data that previously required 16 periods into output data that required only seven periods. U.S. Patent Publication No. 2006/0209965 disclosed a signal processing system, which decodes the SCF, LSCF, CALM and CSF first, stores those data accordingly, and then generates the run-level pairs. An additional signal transformation is executed after the standard CABAC decoding in the signal processing system disclosed. However, even though the run-level coefficient transformation is realized, the total required periods is equal to or even greater than the standard CABAC decoding. In addition, the disclosed signal processing system has to store those data records, which are 16 bits in length, and for an 8×8 block, the disclosed signal processing system, using a last-in-first-out (LIFO) buffer, requires total of 16×64×1=1024 bits of memory. If the stored significant flags, which require 64 bits, are included, a total of 1088 bits of memory is required. If utilizing two LIFO buffers, the required memory will be 16×64×2=2048 bits of memory. If the stored significant flags are included, a total of 2112 bits of memory is required. Such large amount of memory usage does not meet current design requirements.

### BRIEF SUMMARY OF THE INVENTION

The method for processing video signals according to the first embodiment of the present invention comprises the steps of: decoding SCFs according to a stream of video signals and constructing a stack of run coefficients at the same time; and sequentially outputting run coefficients and level coefficients according to the stack of run coefficients and the stream of video signals.

The apparatus for processing video signals according to the second embodiment of the present invention comprises a run coefficient storage module and a run coefficient and level coefficient output module. The run coefficient storage module is configured to calculate and store run coefficients of SCFs of a stream of video signals. The run coefficient and level coefficient output module is configured to decode level coefficients of the video signals and output the run coefficients and level coefficients.

The method for processing video signals according to the third embodiment of the present invention comprises the steps of: decoding SCFs according to a stream of video signals and constructing a stack of run coefficients at the same time; and outputting a stream of run coefficients and level coefficients according to the stack of run coefficient, the SCFs and the stream of video signals.

The apparatus for processing video signals according to the fourth embodiment of the present invention comprises a run coefficient storage module and a run coefficient and level coefficient output module. The run coefficient storage module is configured to calculate and store run coefficients of SCFs of a stream of video signals. The run coefficient and level coefficient output module is configured to decode level coefficients of the video signals and output the run coefficients and level coefficients.

### BRIEF DESCRIPTION OF THE SEVERAL VIEWS OF THE DRAWINGS

The objectives and advantages of the present invention will become apparent upon reading the following description and upon referring to the accompanying drawings.

FIG. 1 shows the flow chart of one part of the first embodiment of the present invention.

FIG. 2 shows the flow chart of another part of the first embodiment of the present invention.

FIG. 3 shows the flow chart of yet another part of the first embodiment of the present invention.

FIG. 4 shows the block diagram of the run coefficient storage module of the second embodiment of the present invention.

FIG. 5 shows the block diagram of the run coefficient and level coefficient output module of the second embodiment of the present invention.

FIG. 6 shows the flow chart of one part of the third embodiment of the present invention.

FIG. 7 shows the flow chart of another part of the third embodiment of the present invention.

FIG. 8 shows the flow chart of yet another part of the third embodiment of the present invention.

FIG. 9 shows the block diagram of the run coefficient storage module of the fourth embodiment of the present invention.

FIG. 10 shows the block diagram of the run coefficient and level coefficient output module of the fourth embodiment of the present invention.

### DETAILED DESCRIPTION OF THE INVENTION

The method for processing video signals according to the first embodiment of the present invention comprises two steps. The first step comprises decoding SCFs according to a stream of video signals and constructing a stack of run coefficient at the same time. The second step comprises sequentially outputting run coefficients and level coefficients according to the stack of run coefficient and the stream of video signals.

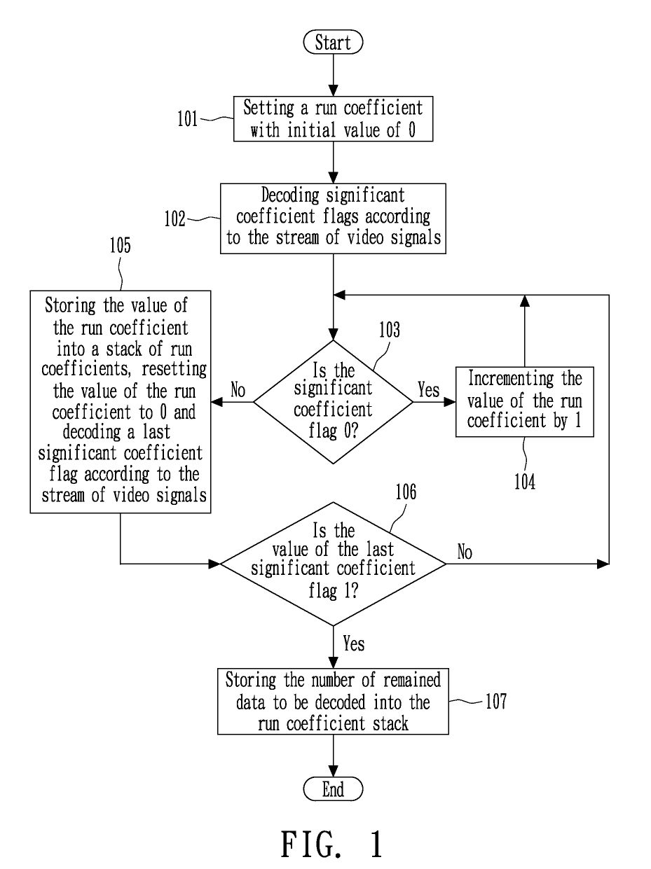

FIG. 1 shows the flow chart of the first step of the first embodiment. In step 101, a run coefficient with initial value of 0 is set, and step 102 is executed. In step 102, an SCF according to the stream of video signals is decoded, and step 103 is executed. In step 103, the value of the SCF is determined. If the value of the SCF is 0, step 104 is executed. Otherwise, step 105 is executed. In step 104, the value of the run coefficient is incremented by 1, and step 102 is executed. In step 105, the value of the run coefficient is stored into a stack of run coefficients, the value of the run coefficient is reset to 0, an LSCF is decoded according to the stream of video signals, and step 106 is executed. In step 106, the value of the LSCF is determined. If the value of the LSCF is 1, step 107 is executed; otherwise, step 102 is executed. In step 107, the number of remaining data records to be decoded is stored into the stack of run coefficients.

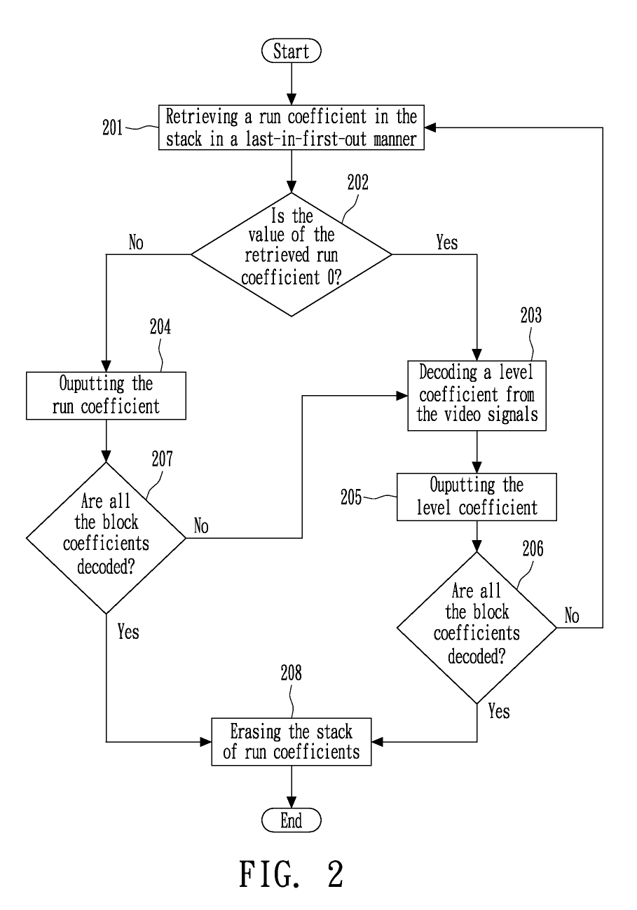

FIG. 2 shows the flow chart of the second step, which outputs data in a flag-data pair manner, of the first embodiment. In step 201, a run coefficient in the stack is retrieved in a LIFO manner, and step 202 is executed. In step 202, the value of the retrieved run coefficient is determined. If the value of the retrieved run coefficient is 0, step 203 is executed; otherwise, step 204 is executed. In step 203, a level coefficient is decoded from the video signals, and step 205 is executed. In step 205, the level coefficient is outputted, and step 206 is executed. In step 206, it is determined whether all the block coefficients are decoded. If all the block coefficients are decoded, step 208 is executed; otherwise, step 201 is executed. In step 204, the run coefficient is outputted, and step 207 is executed. In step 207, it is determined whether all the block coefficients are decoded. If all the block coefficients are decoded, step 208 is executed; otherwise, step 203 is executed. In step 208, the stack of run coefficients is erased, and the block coefficient decoding is ended.

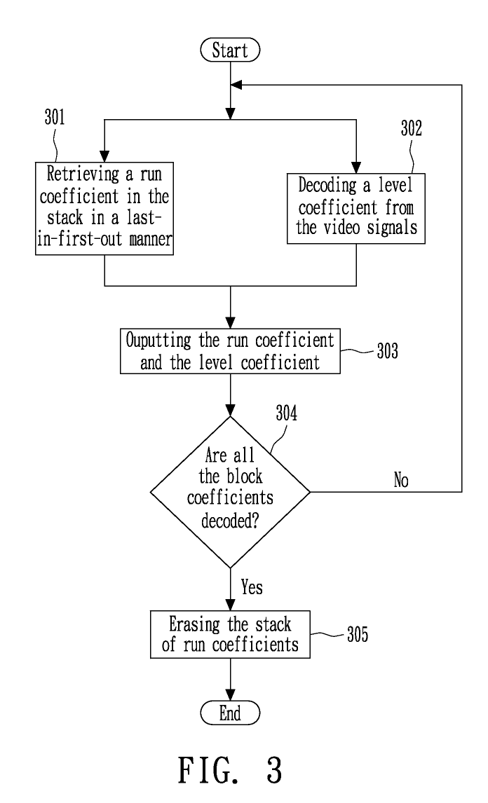

FIG. 3 shows the flow chart of the second step, which outputs data in a run-level pair manner, of the first embodiment. In step 301, a run coefficient in the stack is retrieved in a LIFO manner. In step 302, a level coefficient is decoded from the video signals. It should be noted that step 301 and step 302 have no sequence order, and either can be executed before the other, or both can be executed at the same time. After step 301 and step 302 are completed, step 303 is executed. In step 303, the retrieved run coefficient and the decoded level coefficient are outputted at the same time, and step 304 is executed. In step 304, it is determined whether all the block coefficients are decoded. If all the block coefficients are decoded, step 305 is executed; otherwise, steps 301 and 302 are executed. In step 305, the stack of run coefficients is erased, and the block coefficient decoding is ended.

The apparatus for processing video signals according to the second embodiment of the present invention comprises a run coefficient storage module 400 and a run coefficient and level coefficient output module 500. The run coefficient storage module 400 and the run coefficient and level coefficient output module 500 are for executing the first step and the second step of the first embodiment respectively. The run coefficient storage module 400 is configured to calculate and store run coefficients of SCFs of a stream of video signals. The run coefficient and level coefficient output module 500 is configured to decode level coefficients of the video signals and output the run coefficients and level coefficients.

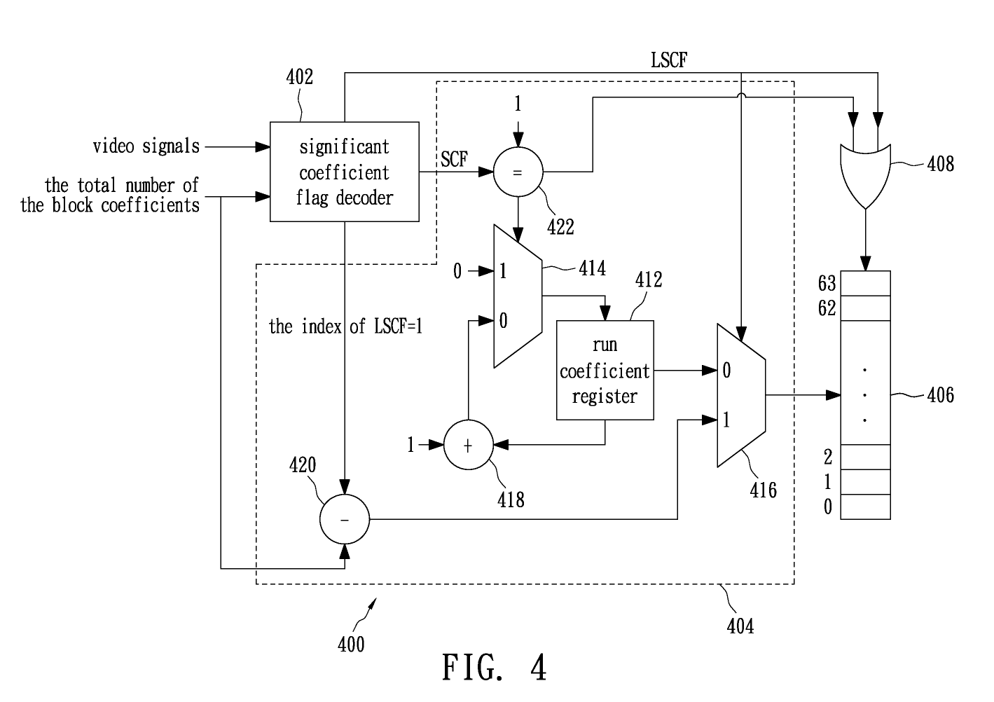

FIG. 4 shows the block diagram of the run coefficient storage module 400. The run coefficient storage module 400 comprises an SCF decoder 402, a run calculating unit 404, a stack of run coefficients 406 and an OR gate 408. The run calculating unit 404 comprises a run coefficient register 412, a second multiplexer 414, a third multiplexer 416, an adder 418, a subtractor 420 and a comparator 422.

The SCF decoder 402 is configured to receive block coefficients of a stream of video signals, such as video signals encoded by CABAC algorithm, and to decode the received block coefficients to generate the SCFs and the LSCFs accordingly. The comparator 422 is configured to receive the decoded SCF outputted from the SCF decoder 402, and to output 1 if the decoded SCF is 1 or output 0 if the decoded SCF is not 1. The second multiplexer 414 is controlled by the comparator 422. If the decoded SCF is 1, the second multiplexer 414 outputs 0 to the run coefficient register 412. If the decoded SCF is 0, the second multiplexer 414 outputs the stored data in the run coefficient register 412 plus 1 to the run coefficient register 412. The adder 418 is configured to increment the stored data in the run coefficient register 412 by 1 and then output to the second multiplexer 414. The third multiplexer 416 is controlled by the LSCFs. If the decoded LSCF is 0, the third multiplexer 416 outputs the stored data in the run coefficient register 412 to the stack of run coefficients 406. If the decoded LSCF is 1, the third multiplexer 416 outputs the number of the remaining data records to be decoded to the stack of run coefficients 406. The subtractor 420 is configured to output the total number of the block coefficients minus the index of the LSCFs to the third multiplexer 416. In other words, the output value of the subtractor 420 is the number of the remain ing data records to be decoded. The OR gate 408 is configured to receive the decoded SCFs and LSCFs. The enable input terminal of the stack of run coefficients 406 is coupled to the output terminal of the OR gate 408.

As shown in FIG. 4, the value in the run coefficient register 412 is initially 0, and is incremented each time the SCF decoder 402 outputs an SCF of value 0. When the SCF decoder 402 outputs an SCF of value 1, the stack of run coefficients 406 is enabled to store the output data of the run coefficient register 412, i.e., the length of the repetition of digits of 0 of the decoded SCFs. At this point, the data in the run coefficient register 412 is reset to 0, and the next run coefficient is calculated. When the decoded LSCF is 1, which means all of the SCFs of the remaining block coefficients are 0, the stack of run coefficients 406 is enabled to store the number of the remaining data records to be decoded. When one of the decoded SCFs or LSCFs is 1, the output data of the third multiplexer 416 is stored into the stack of run coefficients 406.

Referring back to the significant map, which is shown as follows:

| | Index | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| SCF | 1 | 0 | 0 | 1 | 0 | 0 | 0 | 1 | 1 | 0 | 0 | 0 | 0 | 0 | 0 | 0 |
| LSCF | 0 | x | x | x | x | x | x | 0 | 1 | x | x | x | x | x | x | x |

The construction of the stack of run coefficients 406 can be represented as follows:

| | | | Run | Stack of run |
|---|---|---|---|---|
| Index | SCF | LSCF | coefficients | coefficients |
| Initial value | | | 0 | { } |
| 0 | 1 | 0 | 0 | {0} |
| 1 | 0 | x | 0 + 1 | {0} |
| 2 | 0 | x | 1 + 1 | {0} |
| 3 | 1 | 0 | 2 | {0, 2} |
| 4 | 0 | x | 0 + 1 | {0, 2} |
| 5 | 0 | x | 1 + 1 | {0, 2} |
| 6 | 0 | x | 2 + 1 | {0, 2} |
| 7 | 1 | 0 | 3 | {0, 2, 3} |
| 8 | 1 | 1 | 0 | {0, 2, 3, 0} |
| | | | | {0, 2, 3, 0, 7} |

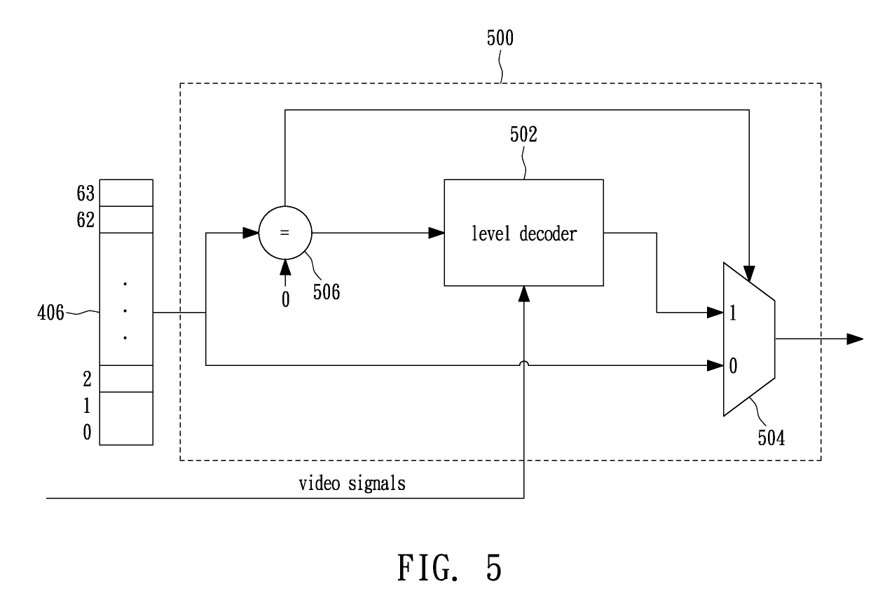

FIG. 5 shows the block diagram of the run coefficient and level coefficient output module 500. The run coefficient and level coefficient output module 500 comprises a level decoder 502, a first multiplexer 504 and a comparator 506. The stack of run coefficients 406 is configured to output the run coefficients in a LIFO manner. The comparator 506 is configured to determine whether the output data of the stack of run coefficients 406 is 0 and to control the level decoder 502 and the first multiplexer 504. When the run coefficient outputted from the stack of run coefficients 406 is 0, the level decoder 502 is enabled to decode a level coefficient of the block coefficients, and the first multiplexer 504 outputs the level coefficient outputted from the level decoder 502. When the run coefficient outputted from the stack of run coefficients 406 is not 0, the first multiplexer 504 outputs the run coefficient.

Referring to the aforesaid example, the output of the level coefficient output module 500 can be represented as follows, which also refers to the flow chart shown in FIG. 2:

| | Stack of run | | |
|---|---|---|---|
| Index | coefficients | Output | Next index |
| 15 | {0, 2, 3, 0, 7} | | 15 |
| 15 | {0, 2, 3, 0, 7} | {run coefficient, 7} | 8 |
| 8 | {0, 2, 3, 0} | {level coefficient, −1} | 7 |
| 7 | {0, 2, 3} | {level coefficient, 1} | 6 |
| 6 | {0, 2} | {run coefficient, 3} | 3 |
| 3 | {0, 2} | {level coefficient, 2} | 2 |
| 2 | {0, 2} | {run coefficient, 2} | 0 |
| 0 | {0} | {level coefficient, 4} | −1 |
| | {0} | | |

The first multiplexer 504 may be omitted and a register utilized instead to store the run coefficient and the level coefficient such as in the flow chart shown in FIG. 3.

Referring to the aforesaid example, the output of the level coefficient output module 500 can also be represented as follows, which may refer to the flow chart shown in FIG. 3:

| | | Output (run | |
|---|---|---|---|
| | Stack of run | coefficents, level | |
| Index | coefficients | coefficients) | Next index |
| 15 | {0, 2, 3, 0, 7} | | 15 |
| 15 | {0, 2, 3, 0, 7} | {7, −1} | 7 |
| 7 | {0, 2, 3, 0} | {0, 1} | 6 |
| 6 | {0, 2, 3} | {3, 2} | 2 |
| 2 | {0, 2} | {2, 4} | −1 |
| −1 | {0} | | |

The method for processing video signals according to the third embodiment of the present invention comprises two steps. The first step comprises decoding SCFs according to a stream of video signals and constructing a stack of run coefficients at the same time. The second step comprises sequentially outputting run coefficients and level coefficients according to the stack of run coefficients, the SCFs and the stream of video signals.

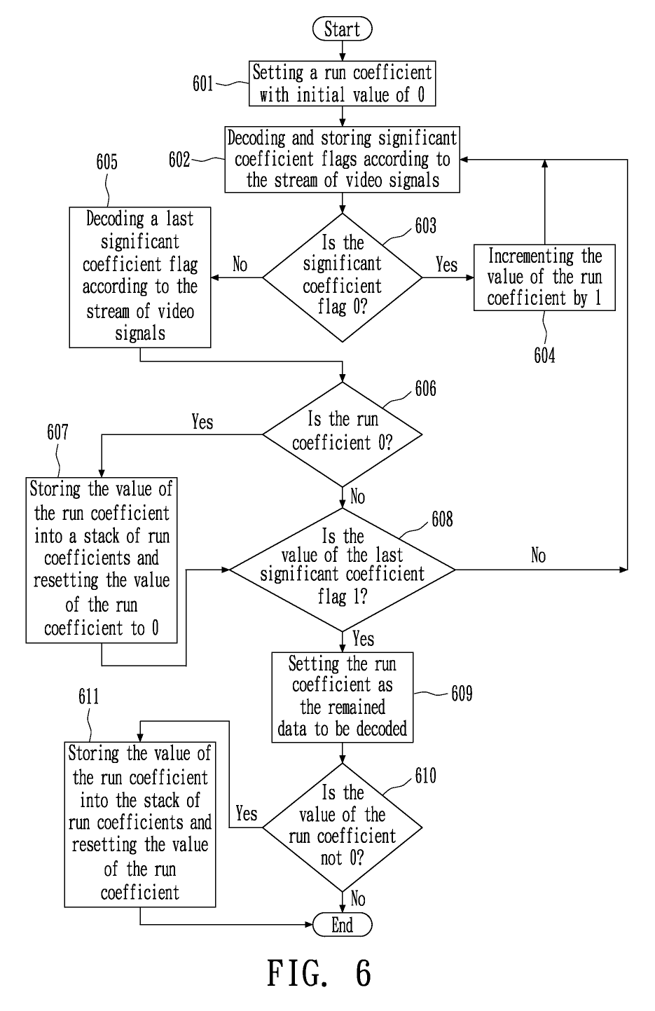

FIG. 6 shows the flow chart of the first step of the third embodiment. In step 601, a run coefficient with initial value of 0 is set, and step 602 is executed. In step 602, an SCF according to the stream of video signals is decoded and stored, and step 603 is executed. In step 603, the value of the SCF is determined. If the value of the SCF is 0, step 604 is executed; otherwise, step 605 is executed. In step 604, the value of the run coefficient is incremented by 1, and step 602 is executed. In step 605, an LSCF is decoded according to the stream of video signals, and step 606 is executed. In step 606, the value of the run coefficient is determined. If the value of the run coefficient is not 0, step 607 is executed; otherwise, step 608 is executed. In step 607, the value of the run coefficient is stored into a stack of run coefficients, the value of the run coefficient is reset to 0, and step 608 is executed. In step 608, the value of the LSCF is determined. If the value of the LSCF is 1, step 609 is executed; otherwise, step 602 is executed. In step 609, the run coefficient is set to equal the number of remaining data records to be decoded, and step 610 is executed. In step 610, the value of the run coefficient is determined. If the value of the run coefficient is not 0, step 611 is executed; otherwise, the block coefficient decoding process is ended. In step 611, the value of the run coefficient is stored into the stack of run coefficients, the value of the run coefficient is reset, and the block coefficient decoding process is ended. The execution of step 605 and group of steps 606, 607 has no sequence order. Either step may be executed before the other, or both can be executed at the same time. The sequence order shown in FIG. 6 is only an example.

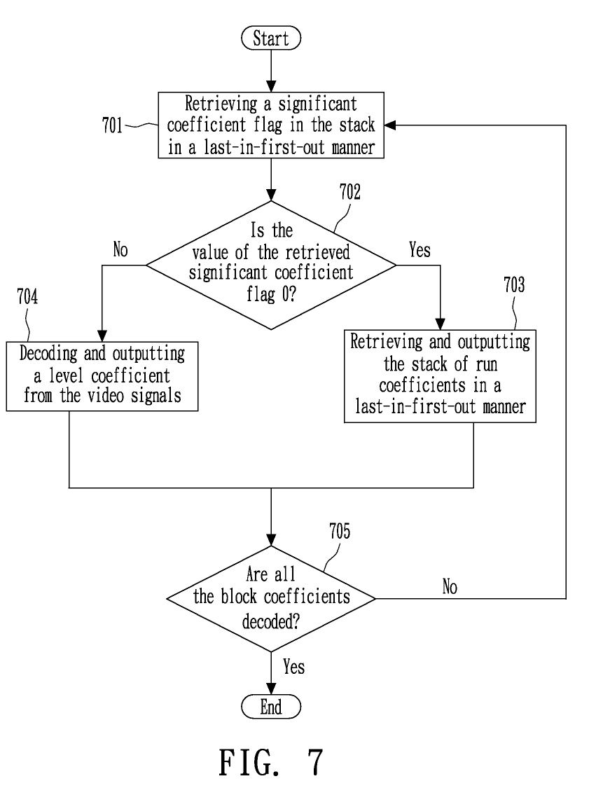

FIG. 7 shows the flow chart of the second step, which outputs data in a flag-data pair manner, of the third embodiment. In step 701, an SCF in the stack is retrieved in a LIFO manner, and step 702 is executed. In step 702, the value of the retrieved SCF is determined. If the value of the retrieved SCF is 0, step 703 is executed; otherwise, step 704 is executed. In step 703, a run coefficient is retrieved from the stack of run coefficients in a LIFO manner and outputted, and step 705 is executed. In step 704, a level coefficient is decoded from the video signals and outputted, and step 705 is executed. In step 705, it is determined whether all the block coefficients are decoded. If all the block coefficients are decoded, the block coefficient decoding is ended; otherwise, step 701 is executed.

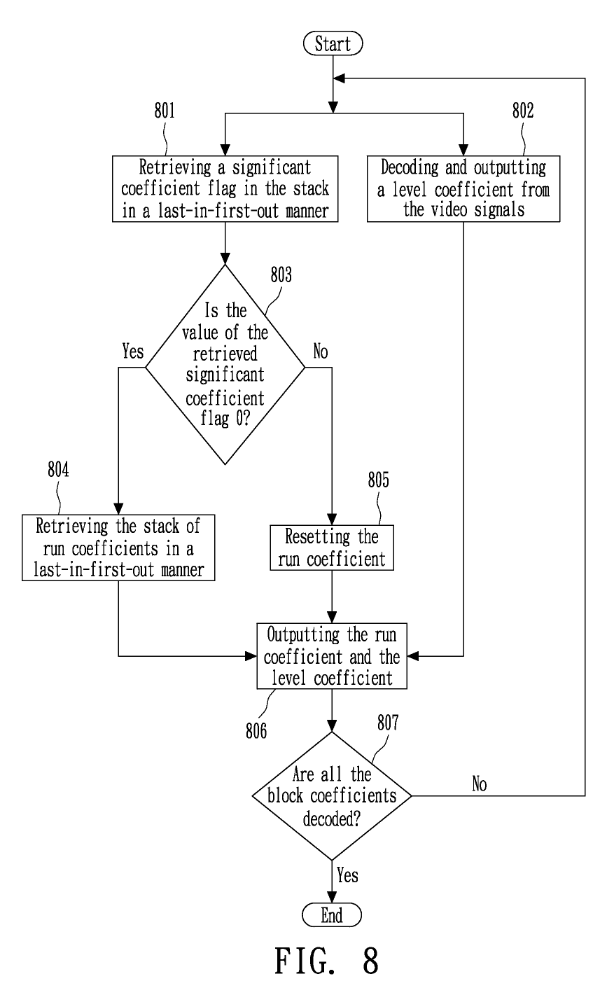

FIG. 8 shows the flow chart of the second step, which outputs data in a run-level pair manner, of the third embodiment. In step 801, an SCF in the stack is retrieved in a LIFO manner, and step 803 is executed. In step 802, a level coefficient is decoded from the video signals and outputted. In step 803, the value of the retrieved SCF is determined. If the value of the retrieved SCF is 0, step 804 is executed; otherwise, step 805 is executed. In step 804, a run coefficient is retrieved from the stack of run coefficients in a LIFO manner. In step 805, the run coefficient is reset to 0. After step 802 and step 804 are both completed, or step 802 and step 805 are both completed, step 806 is executed. In step 806, the run coefficient and the level coefficient are outputted at the same time, and step 807 is executed. In step 807, it is determined whether all the block coefficients are decoded. If all the block coefficients are decoded, the block coefficient decoding is ended; otherwise, steps 801 and 802 are executed.

The execution of step 802 can be performed before, after, or at the same time as the execution of the group of steps 801, 803, 804 and 805. The sequence order shown in FIG. 8 is only an example.

The apparatus for processing video signals according to the fourth embodiment of the present invention comprises a run coefficient storage module 900 and a run coefficient and level coefficient output module 1000. The run coefficient storage module 900 and the run coefficient and level coefficient output module 1000 are for executing the first step and the second step of the third embodiment respectively. The run coefficient storage module 900 is configured to calculate and store run coefficients of SCFs of a stream of video signals. The run coefficient and level coefficient output module 1000 is configured to decode level coefficients of the video signals and output the run coefficients and level coefficients.

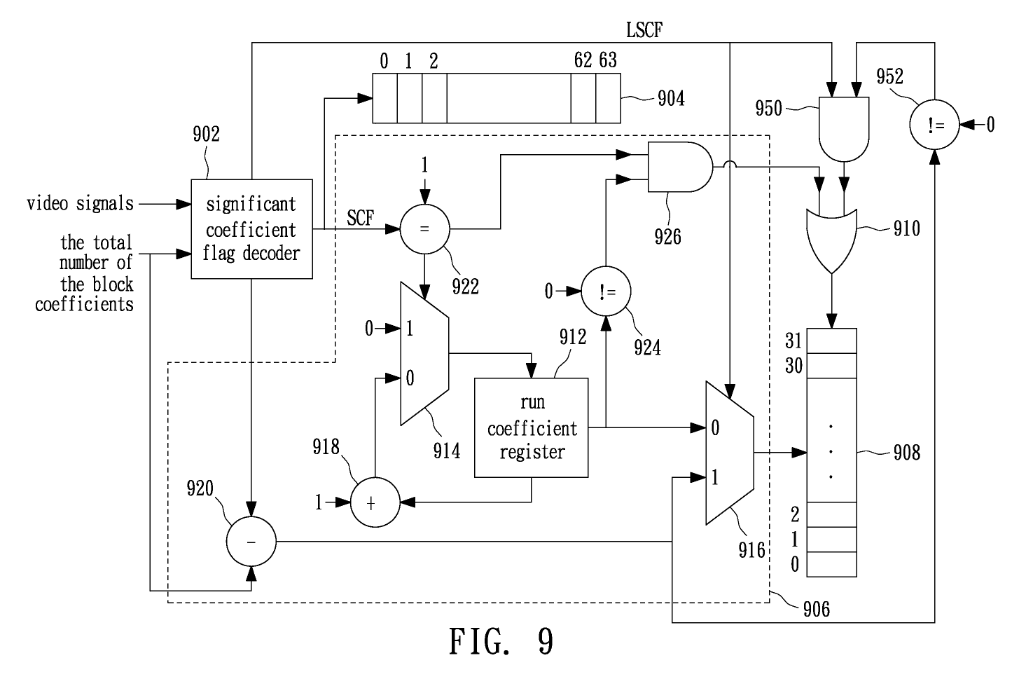

FIG. 9 shows the block diagram of the run coefficient storage module 900. The run coefficient storage module 900 comprises an SCF decoder 902, a significant coefficient register 904, a run calculating unit 906, a stack of run coefficients 908 and an OR gate 910. The run calculating unit 906 comprises a run coefficient register 912, a second multiplexer 914, a third multiplexer 916, an adder 918, a subtractor 920, comparators 922 and 924, AND gates 926 and 950 and a comparator 952.

The SCF decoder 902 is configured to receive block coefficients of a stream of video signals, such as video signals encoded by CABAC algorithm, and decode the received block coefficients to generate the SCFs and the LSCFs accordingly. The significant coefficient register 904 is configured to store the SCFs outputted from the SCF decoder 902. The comparator 922 is configured to receive the SCF outputted from the SCF decoder 902, to output 1 if the decoded SCF is 1, and to output 0 if the decoded SCF is not 1. The second multiplexer 914 is controlled by the comparator 922. If the decoded SCF is 1, the second multiplexer 914 outputs 0 to the run coefficient register 912. If the decoded SCF is 0, the second multiplexer 914 outputs the stored data in the run coefficient register 912 plus 1 to the run coefficient register 912. The adder 918 is configured to increment the data stored in the run coefficient register 912 by 1 and then output to the second multiplexer 914. The third multiplexer 916 is controlled by the LSCFs. If the decoded LSCF is 0, the third multiplexer 916 outputs the data stored in the run coefficient register 912 to the stack of run coefficients 908. If the decoded LSCF is 1, the third multiplexer 916 outputs the number of the remaining data records to be decoded to the stack of run coefficients 908. The subtractor 920 is configured to output the total number of the block coefficients minus the index of the LSCFs to the third multiplexer 916. In other words, the output data of the subtractor 920 is the number of the remaining data records to be decoded. The comparator 924 is configured to receive the run coefficients outputted from the run coefficient register 912, to output 1 if the received run coefficient is not 0, and to output 0 if the received run coefficient is 0. The comparator 952 is configured to receive the output data of the subtractor 920, i.e., the number of the remaining data records to be decoded, to output 1 if the number of the remaining data records to be decoded is not 0, and to output 0 if otherwise. The input terminals of the AND gate 926 are coupled to the output terminals of the comparators 922 and 924. The input terminals of the AND gate 950 are coupled to the output terminals of the comparators 952 and LSCFs outputted from the SCF decoder 902. The input terminals of the OR gate 910 are coupled to the output terminals of the AND gates 926 and 950. The enable input terminal of the stack of run coefficients 908 is coupled to the output terminal of the OR gate 910.

As shown in FIG. 9, the value in the run coefficient register 912 is initially 0, and is incremented each time the SCF decoder 902 outputs a SCF of value 0. When the SCF decoder 902 outputs a SCF of value 1, the stack of run coefficients 908 is enabled to store the output data of the run coefficient register 912, i.e., the length of the repetition of digits of 0 of the SCFs. At this point, the data in the run coefficient register 912 is reset to 0, and the next run coefficient is calculated. When the decoded LSCF is 1, which means all of the SCFs of the remaining block coefficients are 0, the stack of run coefficients 908 is enabled to store the number of the remaining data records to be decoded. To further reduce the required bits in the stack of run coefficients 908, the run coefficient storage module 900 does not store run coefficients of value 0 into the stack of run coefficients 908. Whenever a decoded SCF is 1 and the data stored in the run coefficient register 912 is not 0, or the value of the decoded LSCF is 1 and the remaining block coefficients are not 0, the stack of run coefficients 908 is enabled by the OR gate 910 to store the output data of the third multiplexer 916.

Referring to the aforesaid example, the construction of the stack of run coefficients 908 can be represented as follows:

| | | | Run | Stack of run |
|---|---|---|---|---|
| Index | SCF | LSCF | coefficients | coefficients |
| Initial value | | | 0 | { } |
| 0 | 1 | 0 | 0 | { } |
| 1 | 0 | x | 0 + 1 | { } |
| 2 | 0 | x | 1 + 1 | { } |
| 3 | 1 | 0 | 2 | {2} |
| 4 | 0 | x | 0 + 1 | {2} |
| 5 | 0 | x | 1 + 1 | {2} |
| 6 | 0 | x | 2 + 1 | {2} |
| 7 | 1 | 0 | 3 | {0, 2, 3} |
| 8 | 1 | 1 | 0 | {0, 2, 3} |
| | | | | {0, 2, 3, 0, 7} |

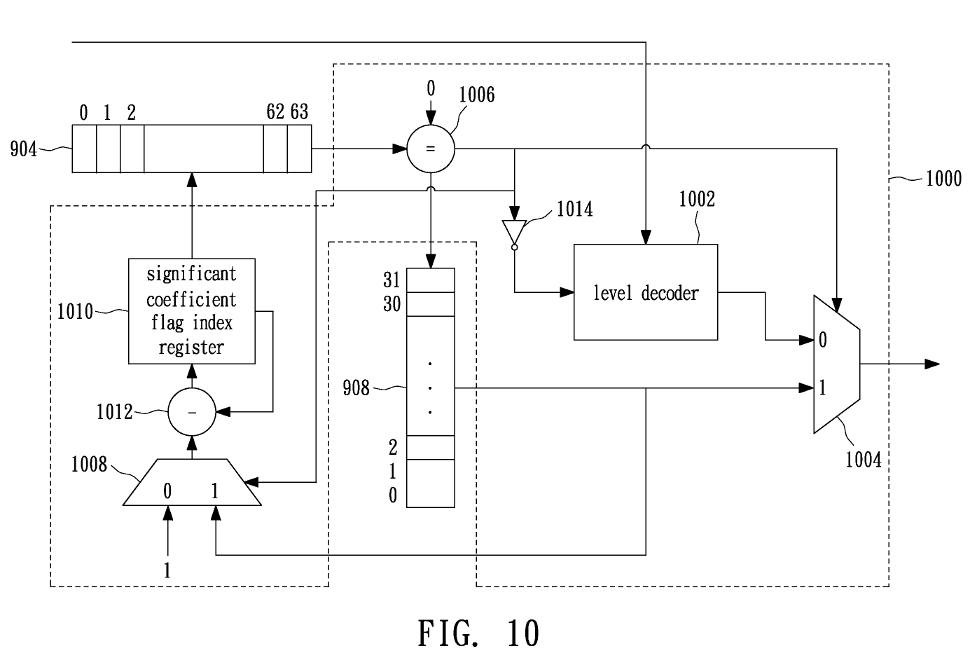

FIG. 10 shows the block diagram of the run coefficient and level coefficient output module 1000. The run coefficient and level coefficient output module 1000 comprises a level decoder 1002, a first multiplexer 1004, a comparator 1006, a fourth multiplexer 1008, an SCF index register 1010, a subtracter 1012 and an inverter 1014. The comparator 1006 is configured to determine if the output data of the significant coefficient register 904 is 0 and to control the level decoder 1002, the first multiplexer 1004 and the fourth multiplexer 1008. The inverter 1014 is configured to couple the inverse signal of the output data of the comparator 1006 to the level decoder 1002. When an SCF outputted from the significant coefficient register 904 is not 0, the level decoder 1002 is enabled to decode a level coefficient of the block coefficients, and the first multiplexer 1004 outputs the level coefficient outputted from the level decoder 1002. When an SCF outputted from the significant coefficient register 904 is 0, the first multiplexer 1004 outputs a run coefficient outputted from the stack of run coefficients 908, wherein the stack of run coefficients 908 outputs the run coefficient in a LIFO manner. The fourth multiplexer 1008, the SCF index register 1010 and the subtracter 1012 are configured to control the significant coefficient register 904. The significant coefficient register 904 is configured to output SCFs in a LIFO manner. The SCF index register 1010 is configured to store the index of the significant coefficient register 904, wherein the index represents the address of the data being outputted of the significant coefficient register 904. When the output data of the comparator 1006 is 1, i.e., the output data of the significant coefficient register 904 is 0, the subtracter 1012 stores the data of the current index minus the value of the run coefficient into the SCF index register 1010. When the output data of the comparator 1006 is 0, the subtracter 1012 stores the value of the current index minus 1 into the SCF index register 1010.

Referring to the aforesaid example, the output of the run coefficient and level coefficient output module 1000 can be represented as follows:

| | Stack of run | | |
|---|---|---|---|
| Index | coefficients | Output | Next index |
| 15 | {2, 3, 7} | | |
| 15 | {2, 3, 7} | {run coefficient, 7} | 8 |
| 8 | {2, 3,} | {level coefficient, −1} | 7 |
| 7 | {2, 3} | {level coefficient, 1} | 6 |
| 6 | {2} | {run coefficient, 3} | 3 |
| 3 | {2} | {level coefficient, 2} | 2 |
| 2 | {2} | {run coefficient, 2} | 2 |
| 0 | { } | {level coefficient, 4} | −1 |

The first multiplexer 1004 may be omitted and utilize a register instead to store the run coefficient and the level coefficient as in the flow chart shown in FIG. 8.

Referring to the aforesaid example, the output of the run coefficient and level coefficient output module 1000 can also be represented as follows, which refers to the flow chart shown in FIG. 8:

| | | Output (run | |
|---|---|---|---|
| | Stack of run | coefficents, level | |
| Index | coefficients | coefficients) | Next index |
| 15 | {2, 3, 7} | | |
| 15 | {2, 3, 7} | {7, −1} | 7 |
| 7 | {2, 3} | {0, 1} | 6 |
| 6 | {2, 3} | {3, 2} | 2 |
| 2 | {2} | {2, 4} | −1 |
| −1 | { } | | |

Since the video signal processing apparatus and method of the present invention does not require the storage of level coefficients, the memory usage requirement is largely reduced. For an 8×8 block, the video signal processing apparatus in the second embodiment only has to store 64 run coefficients at most. If each run coefficient is 6 bits in length, only 384 bits of memory are required. Since the video signal processing apparatus in the fourth embodiment does not require the storage of run coefficients of value 0, it only has to store 32 run coefficients at most. If each run coefficient is 6 bits in length, only 192 bits of memory are required. If the stored SCFs, which are 64 bits each, are taken into account, only 256 bits of memory are required. Compared with the aforementioned conventional techniques, the memory usage requirement has been reduced by one numerical order.

As to computing speed, compared with the conventional video signal processing apparatus that does not utilize run coefficient output manner, the video signal processing apparatus and method according to the present invention improves the computing speed by 77% to 86%. On the other hand, compared with the aforementioned conventional video signal processing apparatus, the video signal processing apparatus and method according to the present invention also improve the computing speed by 47% to 73%.

In addition, the run coefficient and level coefficient output module in the present invention not only can output the run coefficient and level coefficient separately, but also can output the run coefficient and level coefficient at the same time.

In conclusion, the video signal processing apparatus and method according to the embodiments might improve the output efficiency by utilizing a run-level coefficient output manner, and the level coefficients could not have to be stored during the signal processing process.

The above-described embodiments of the present invention are intended to be illustrative only. Those skilled in the art may devise numerous alternative embodiments without departing from the scope of the following claims.

We claim:

1. A method for processing video signals, comprising the steps of:
decoding significant coefficient flags according to a stream of video signals and constructing a stack of run coefficients at the same time; and
sequentially outputting run coefficients and level coefficients according to the stack of run coefficients and the stream of video signals.

2. The method of claim 1, wherein the constructing step comprises the steps of:
setting a run coefficient with initial value 0;
incrementing the value of the run coefficient by 1 if the value of the decoded significant coefficient flag is 0; and
storing the value of the run coefficients into a stack of run coefficients and resetting the value of the run coefficient to 0 if the value of the decoded significant coefficient flag is 1.

3. The method of claim 2, wherein the constructing step further comprises the step of:
storing the number of remaining data records to be decoded into the stack of run coefficients if the decoded significant coefficient flag is the last one having a value of 1.

4. The method of claim 1, wherein the outputting step comprises the steps of:
retrieving the run coefficients in the stack in a last-in-first-out manner;
outputting a level coefficient decoded from the video signals if the retrieved run coefficient is 0; and
outputting the retrieved run coefficient if the retrieved run coefficient is not 0.

5. The method of claim 1, wherein the outputting step comprises the steps of:
retrieving the run coefficients in the stack in a last-in-first-out manner;
decoding a level coefficient from the video signals; and
outputting the retrieved run coefficient and the decoded level coefficient at the same time.

6. A method for processing video signals, comprising the steps of:
decoding significant coefficient flags according to a stream of video signals and constructing a stack of run coefficients at the same time; and
outputting a stream of run coefficients and level coefficients according to the stack of run coefficients, the significant coefficient flags and the stream of video signals.

7. The method of claim 6, wherein the constructing step comprises the steps of:
setting a run coefficient with initial value 0;
storing the decoded significant coefficient flags;
incrementing the value of the run coefficient by 1 if the value of the decoded significant coefficient flag is 0; and
storing the value of the run coefficient into the stack of run coefficients and resetting the value of the run coefficient to 0 if the value of the decoded significant coefficient flag is 1 and the value of the run coefficient is not 0.

8. The method of claim 7, wherein the constructing step further comprises the steps of:
storing the number of remaining data records to be decoded into the stack of run coefficients if the decoded significant coefficient flag is the last one having a value of 1 and the number of the remaining data records to be decoded is not 0.

9. The method of claim 6, wherein the outputting step comprises the steps of:
retrieving the stored significant coefficient flags in a last-in-first-out manner;
outputting a level coefficient decoded from the video signals if the retrieved significant coefficient flag is not 0; and
outputting a run coefficient in a last-in-first-out manner in the stack if the retrieved significant coefficient flag is 0.

10. The method of claim 6, wherein the constructing step comprises the steps of:
retrieving the stored significant coefficient flags in a last-in-first-out manner;
decoding a level coefficient from the video signals;
setting the run coefficient as 0 if the retrieved significant coefficient flag is not 0;
retrieving a stored run coefficient from the stack of run coefficients in a last-in-first-out manner if the retrieved significant coefficient flag is 0; and
outputting the retrieved run coefficient and the decoded level coefficient at the same time.

11. An apparatus for processing video signals, comprising:
a run coefficient storage module configured to calculate and to store run coefficients of significant coefficient flags of a stream of video signals, comprising:
a significant coefficient flag decoder configured to decode significant coefficient flags and last significant coefficient flags of the video signals;
a run calculating unit configured to calculate and store the run coefficients of the significant coefficient flags; and
a stack of run coefficients configured to store the output of the run calculating unit and output the stored value in a last-in-first-out manner; and
a run coefficient and level coefficient output module configured to decode level coefficients of the video signals and output the run coefficients and level coefficients, comprising:
a level decoder configured to decode the level coefficients according to the output data of the stack of run coefficients and the video signals.

12. The apparatus of claim 11, wherein the run coefficient and level coefficient output module further comprises:
a first multiplexer configured to output the run coefficients or the level coefficients according to the output of the stack of run coefficients.

13. The apparatus of claim 11, wherein the stack of run coefficients is configured to store the output data of the run calculating unit if the decoded significant coefficient flag or the decoded last significant coefficient flag is 1.

14. The apparatus of claim 11, wherein the level decoder is configured to decode the level coefficients if the output data of the stack of run coefficients is 0.

15. The apparatus of claim 11, wherein the run coefficient and the level coefficient are outputted at the same time.

16. The apparatus of claim 12, wherein the first multiplexer is configured to output the output data of the stack of run coefficients if the output data of the stack of run coefficients is not 0 and output the output data of the level decoder if the output data of the stack of run coefficients is 0.

17. The apparatus of claim 11, wherein the run calculating unit comprises:
a run coefficient register configured to store the run coefficients of the significant coefficient flags;
a second multiplexer configured to output 0 to the run coefficient register if the corresponding significant coefficient flag is 1 and output the output data of the run coefficient register plus 1 to the run coefficient register if the corresponding significant coefficient flag is 0; and
a third multiplexer configured to output the output data of the run coefficient register to the stack of run coefficients if the decoded last significant coefficient flag is 0 and output the number of the remaining data records to be decoded to the stack of run coefficients if the decoded last significant coefficient flag is 1.

18. An apparatus for processing video signals, comprising:
a run coefficient storage module configured to calculate and to store run coefficients of significant coefficient flags of a stream of video signals, comprising:
a significant coefficient flag decoder configured to decode significant coefficient flags and last significant coefficient flags of the video signals;
a significant coefficient flag register configured to store the significant coefficient flags;
a run calculating unit configured to calculate and store the run coefficients of the significant coefficient flags; and
a stack of run coefficients configured to store the output of the run calculating unit and output the stored data in a last-in-first-out manner; and
a run coefficient and level coefficient output module configured to decode level coefficients of the video signals and output the run coefficients and level coefficients, comprising:
a level decoder configured to decode the level coefficients according to the output of the significant coefficient flag register and the video signals.

19. The apparatus of claim 18, wherein the run coefficient and level coefficient output module further comprises:
a first multiplexer configured to output the run coefficients or the level coefficients according to the output data of the significant coefficient flag register.

20. The apparatus of claim 18, wherein the stack of run coefficients is configured to store the output of the run calculating unit if the decoded significant coefficient flag is not 0 and the stored data in the run calculating unit is not 0, or if the decoded last significant coefficient flag is 1 and the number of the remaining data records to be decoded is not 0.

21. The apparatus of claim 18, wherein the level decoder is configured to decode the level coefficients if the output of the significant coefficient flag register is 1.

22. The apparatus of claim 18, wherein the run coefficient and the level coefficient are outputted at the same time.

23. The apparatus of claim 19, wherein the first multiplexer is configured to output the output data of the stack of run coefficients if the output data of the significant coefficient flag register is 0 and output the output data of the level decoder if the output data of the significant coefficient flag register is 1.

24. The apparatus of claim 18, wherein when the output data of the significant coefficient flag register is 1, the next output data of the significant coefficient flag register is the next stored significant coefficient flag, and when the output of the significant coefficient flag register is 0, the next output of the significant coefficient flag register is the next significant coefficient flag of value 1.

25. The apparatus of claim 18, wherein the run calculating unit comprises:
a run coefficient register configured to store the run coefficients of the significant coefficient flags;
a second multiplexer configured to output 0 to the run coefficient register if the corresponding significant coefficient flag is 1 and output the output data of the run coefficient register plus 1 to the run coefficient register if the corresponding significant coefficient flag is 0; and
a third multiplexer configured to output the output data of the run coefficient register to the stack of run coefficients if the decoded last significant coefficient flag is 0 and output the number of remaining data records to be decoded to the stack of run coefficients if the decoded last significant coefficient flag is 1.
